(19) United States
(12) Patent Application Publication
(10) Pub. No.: US 2012/0051555 A1
(43) Pub. Date: Mar. 1, 2012

(54) AUTOMATIC VOLUME CONTROL BASED ON ACOUSTIC ENERGY EXPOSURE

(75) Inventors: Andre Gustavo P. Schevciw, San Diego, CA (US); Brian Momeyer, Carlsbad, CA (US); Wade L. Heimbigner, Poway, CA (US)

(73) Assignee: QUALCOMM Incorporated, San Diego, CA (US)

(21) Appl. No.: 13/215,935

(22) Filed: Aug. 23, 2011

Related U.S. Application Data
(60) Provisional application No. 61/376,610, filed on Aug. 24, 2010.

(51) Int. Cl. H04R 1/10

(52) U.S. Cl. 381/74

(57) ABSTRACT

A method for adjusting volume in a headset based on accumulated acoustic energy density exposure is disclosed. A sound pressure value of a microphone positioned in a user's ear canal is measured. A current accumulated acoustic energy density exposure is determined based on sound pressure values measured during the rolling window. The maximum volume in the headset is adjusted based on a comparison of the current accumulated energy density exposure to a predetermined threshold.

### RELATED APPLICATIONS

This application is related to and claims priority from U.S. Provisional Patent Application Ser. No. 61/376,610 filed Aug. 24, 2010, for “Automatic Volume Control based on Acoustic Energy Exposure.”

### TECHNICAL FIELD

The present disclosure relates generally to communication systems. More specifically, the present disclosure relates to automatic volume control based on acoustic energy exposure.

### BACKGROUND

Electronic devices (cellular telephones, wireless modems, computers, digital music players, Global Positioning System units, Personal Digital Assistants, gaming devices, etc.) have become a part of everyday life. Small computing devices are now placed in everything from automobiles to housing locks. The complexity of electronic devices has increased dramatically in the last few years. For example, many electronic devices have one or more processors that help control the device, as well as a number of digital circuits to support the processor and other parts of the device.

Electronic devices may be connected to headphones or speakers to listen to music or other programming However, prolonged use of headphones or speakers may pose a risk to a user's hearing. As such, measures may be taken to ensure that a user does not damage his or her hearing. Therefore, benefits may be realized for automatic volume control based on acoustic energy exposure.

### SUMMARY OF THE INVENTION

A method for adjusting volume in a headset based on accumulated acoustic energy density exposure is disclosed. A sound pressure value of a microphone positioned in a user's ear canal is measured. A current accumulated acoustic energy density exposure is determined based on sound pressure values measured during the rolling window. The maximum volume in the headset is adjusted based on a comparison of the current accumulated energy density exposure to a predetermined threshold.

The measuring may be performed every 1 second. Determining the current accumulated acoustic energy density exposure may include determining an accumulated acoustic energy density exposure according to the following equation:

$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ]$$

where frml is the time length of the measurement frame for the acoustic sound pressure, i is a measurement frame counter and Pₑ(i) is the measured effective acoustic sound pressure during the frame i, t₁ is a starting time of the rolling window, t₂ is an ending time of the rolling window, ρₒ is an equilibrium density of air and c is a speed of sound constant. The determining the current accumulated acoustic energy density exposure may further include summing multiple accumulated acoustic energy density exposures during the rolling window.

The rolling window may span one of at least 8 hours, 24 hours or one week. The rolling window may span at least one hour. A table of sound pressure level measurements may be periodically updated for a time period where the media player coupled to the headset is active in headset mode.

A headset for adjusting a maximum volume based on accumulated acoustic energy density exposure is also disclosed. The headset includes a processor and memory in electronic communication with the processor. Executable instructions are stored in the memory. The instructions are executable to measure sound pressure values of a microphone positioned in user's ear canal. The instructions are also executable to determine a current accumulated acoustic energy density exposure based on sound pressure values measured during the rolling window. The instructions are also executable to adjust the maximum volume in the headset based on a comparison of the current accumulated acoustic energy density exposure to a predetermined threshold.

A headset for adjusting a maximum volume based on accumulated acoustic energy density exposure is also disclosed. The headset includes means for measuring sound pressure values of a microphone positioned in a user's ear canal. The headset also includes means for determining a current accumulated acoustic energy density exposure based on sound pressure values measured during the rolling window. The headset also includes means for adjusting the maximum volume in the headset based on a comparison of the current accumulated acoustic energy density exposure to a predetermined threshold.

A computer-program product for adjusting a maximum volume in a headset based on accumulated acoustic energy density exposure is also disclosed. The computer-program product includes a non-transitory computer-readable medium having instructions thereon. The instructions include code for causing a headset to measure sound pressure values of a microphone positioned in a user's ear canal. The instructions also include code for causing the headset to determine a current accumulated acoustic energy density exposure based on sound pressure values measured during the rolling window. The instructions also include code for causing the headset to adjust the maximum volume in the headset based on a comparison of the current accumulated acoustic energy density exposure to a predetermined threshold.

### BRIEF DESCRIPTION OF THE DRAWINGS

FIG. 1 is a block diagram illustrating a headset and a wireless communication device that may implement automatic volume control based on accumulated acoustic energy density exposure;

FIG. 2 is a plot illustrating safe sound pressure levels as a function of time exposed;

FIG. 3 is a block diagram of an accumulated acoustic energy density exposure calculator in an audio digital signal processor (DSP);

FIG. 4 is a plot illustrating output limit as a function of accumulated acoustic energy density exposure;

FIG. 5 is a block diagram illustrating an accumulated acoustic energy density exposure module;

FIG. 6 is a flow diagram illustrating a method for automatic volume control based on accumulated acoustic energy density exposure;

FIG. 7 is a plot illustrating two timelines for which the present systems and methods may limit the volume in a headset;

FIG. 8 illustrates certain components that may be included within a headset; and

FIG. 9 illustrates certain components that may be included within a wireless communication device.

### DETAILED DESCRIPTION

It may be desirable to limit voltage at a headset terminal to a significantly low value to prevent excessive sound pressure exposure that may cause hearing loss. Since a direct form of determining the sound pressure level that the user is listening to is generally not available with conventional headsets, regulations err on the conservative side, thus limiting the output to the worst case scenario. This may result in poor enjoyment of audio content for the user. The present systems and methods may protect a user from excessive sound pressure exposure while avoiding unnecessary limitation of the output.

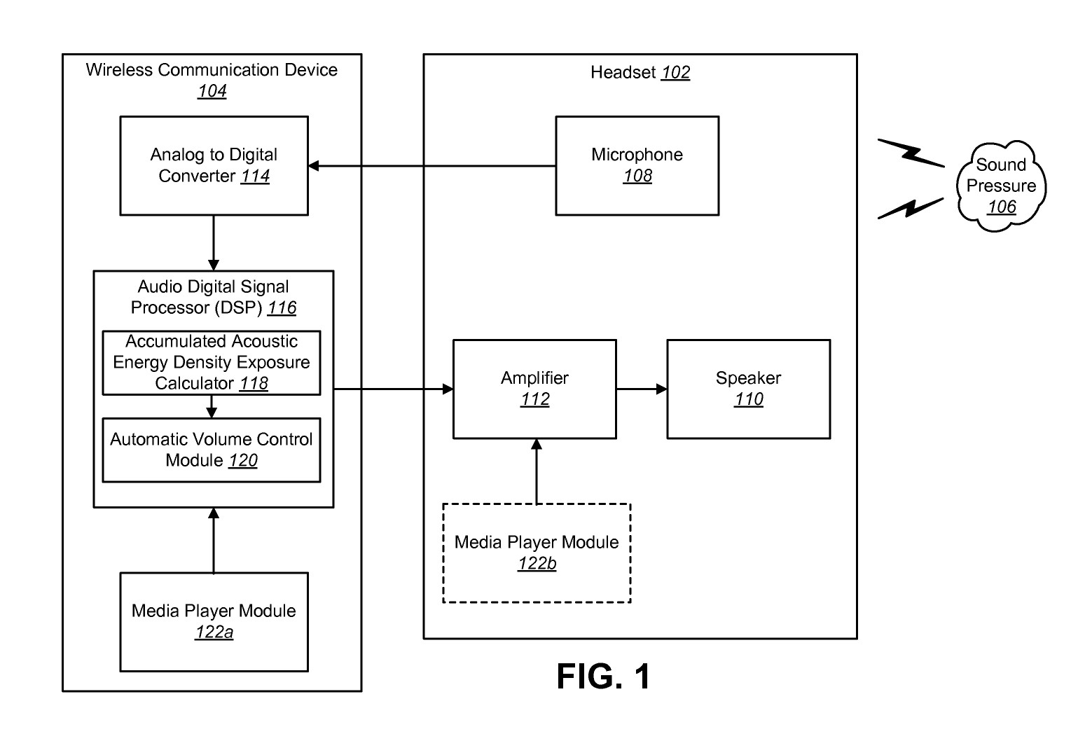

FIG. 1 is a block diagram illustrating a headset 102 and a wireless communication device 104 that may implement automatic volume control based on accumulated acoustic energy density exposure. The headset 102 may include a microphone 108 and a speaker 110. In one configuration, the headset 102 may be a noise cancellation headset and the microphone 108 may be positioned close to the speaker for noise cancellation purposes. In order to perform automatic volume control based on accumulated acoustic energy density exposure, the microphone 108 may measure sound pressure 106 values.

One possible way to determine sound pressure 106 in a headset 102 may be to predict the sound pressure 106 level based on the sensitivity of the speaker 110. More specifically, the sound pressure 106 may be estimated based on a reading of electrical power into the headset 102 using a sensitivity of the headset 102. However, this uses a general model for all people's ear canal characteristics. In practice, each person's ear canal and insert fit may be slightly different and have a different effect on the sound pressure 106 experienced by the user. Therefore, a general model for all people may not be very accurate for some people because it does not actually measure the sound pressure 106 level inside the ear canal. Furthermore, this configuration also assumes that various electrical components (e.g., resistors) in the headset 102 do not degrade over time, which may not be true.

In contrast, the microphone 108 of present systems and methods may measure the actual sound pressure 106 inside the user's ear canal. This measurement accounts for the specific user's ear characteristics and does not assume that electrical components will not degrade over time. More specifically, the microphone 108 may be positioned in the user's ear so that it reflects the actual characteristics of the specific user's ear canal. Alternatively, the headset 102 may be implemented in a wireless communication device 104 (e.g., cell phone) and the microphone 108 may be a conventional microphone 108, i.e., in the mouthpiece.

As used herein, the term “wireless communication device” 104 refers to an electronic device that may be used for voice and/or data communication over a wireless communication system. Examples of wireless communication devices 104 include cellular phones, personal digital assistants (PDAs), handheld devices, wireless modems, laptop computers, personal computers, tablets, etc. A wireless communication device 104 may alternatively be referred to as an access terminal, a mobile terminal, a mobile station, a remote station, a user terminal, a terminal, a subscriber unit, a subscriber station, a mobile device, a wireless device, user equipment (UE) or some other similar terminology.

Alternatively, the headset 102 may be a Bluetooth headset 102 that communicates with a wireless communication device 104, i.e., extends the functionality of the wireless communication device 104 to allow a user hands-free operation. The microphone 108 may monitor the sound pressure 106 level to which the user of the headset 102 is being exposed. The signal received at the microphone 108 may be converted to a digital signal using an analog to digital converter 114. This may include sampling an analog signal to create periodic digital data.

In order to protect the hearing of a headset 102 user, the sound pressure 106 exposure or acoustic energy density exposure of the user may be monitored and adjusted. One possible way to do this is to limit the voltage produced by a media player 122a connected to the headset 102. Alternatively, the media player 122b may reside in the headset 102. However, neither configuration accounts for the sensitivity of the headset 102, i.e., different headsets 102 may result in different sound pressure 106 and acoustic energy density experienced by the user. Therefore, this may unnecessarily limit the sound pressure 106 level based on a worst-case scenario. Another possible way is to implement a hard limit for the sound pressure 106 level experienced by the user. However, this may not account for the amount of time during which the user has been exposed to the sound pressure 106 level, i.e., safe limits for sound exposure may vary based on the time exposed. Therefore, a hard limit may unnecessarily limit the sound pressure level if it does not account for the time exposed.

The present systems and methods may use actual sound pressure 106 value measurements and convert it into energy to account for the time exposed in order to perform automatic volume control. The digital audio information (e.g., originating at the microphone 108 in the user's ear canal) may be fed into an audio digital signal processor (DSP) 116 to track the user's exposure to audio throughout a window, e.g., 8 hours, 12 hours, 24 hours, etc. The audio DSP 116 may be on a wireless communication device 104 or a headset 102.

One possible way to monitor the user's exposure to audio may be to detect a threshold (e.g., a sound pressure 106 level threshold) and start a timer associated with the threshold. When the sound pressure 106 level has been equal to or greater than the threshold for a predetermined period of time, the volume may be limited. For example, if the sound pressure 106 level presented to a user is equal or above 85 dB SPL(A) for 8 hours, 88 dB SPL(A) for 4 hours, 91 dB SPL(A) for 2 hours, 94 dB SPL(A) for 1 hour or 97 dB SPL(A) for 0.5 hours, the volume may be limited. However, this may not be very accurate in some situations because a user may experience sound pressure 106 at multiple levels, neither of which exceeds its respective threshold for a prohibited duration. For example, assume a user was subjected, over 8 hours, to 85 dB SPL(A) for 6 hours, 91 dB SPL(A) for 1 hour and 84 dB SPL(A) for 1 hour. In this case, the accumulated acoustic energy density exposure may be unsafe, but the volume may not be limited because none of the individual thresholds have been exceeded.

Therefore, the present systems and methods may maintain a rolling window for which the accumulated acoustic energy density exposure is calculated. This window may be 8 hours, 12 hours, 24 hours, etc. An accumulated acoustic energy density buffer may be maintained for the window that is updated periodically, e.g., every 1 second. When updated, this buffer may discard the oldest values and determine the accumulated acoustic energy density exposure for all sound pressure 106 levels measured during the window. Thus, even if the sound pressure 106 level does not exceed its respective threshold for a prohibited duration, the volume may still be reduced because the accumulated acoustic energy density exposure accounts for all sound pressure 106 levels measured during the window. Once it is determined that the user has or is close to exceeding their noise exposure limit (e.g., as indicated by the accumulated acoustic energy density exposure) the maximum volume permissible may be reduced.

In other words, after the electrical signal from the microphone 108 is converted to the digital domain, the sound pressure 106 level may be logged over time along with the playback time information. The playback time information may be received from a media player module 122a-b or a timer (not shown) in the audio DSP 116. The accumulated acoustic energy density exposure calculator 118 may accumulate the acoustic energy density presented to the user during the rolling window and use that information to control the automatic volume control module 120 in the audio DSP 116 and adjust the overall system gain, i.e., the maximum output volume of the headset 102 speaker 110 may be adjusted based on the accumulated acoustic energy density experienced by the user. The acoustic energy may be proportional to the square of the sound pressure 106 multiplied by time, i.e., current sound pressure 106 values may be measured, converted to power levels (using a square operation) and then converted to energy by accumulating or integrating the power levels over time. The audio sent to the speaker 110 in the headset 102 may be amplified by an amplifier 112. In a configuration where the media player 122b resides in the headset 102 (instead of the wireless communication device 104), the audio DSP 116 may control a gain register in the amplifier 112.

Any suitable configuration of the wireless communication device 104 and the headset 102 may be used to implement automatic volume control based on accumulated acoustic energy density exposure. For example, the device (illustrated as a wireless communication device 104) attached to the headset 102 may not be wireless or the microphone 108 may be a digital microphone (thus eliminating the analog to digital converter 114). Furthermore, the external device (e.g., wireless communication device 104) may communicate with the headset wirelessly, or the amplifier 112 may reside on the external device (e.g., wireless communication device 104).

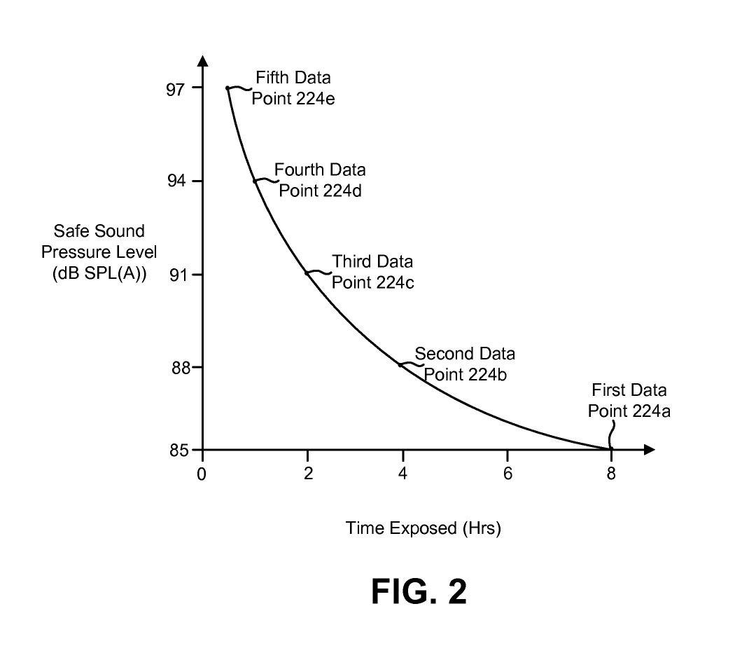

FIG. 2 is a plot illustrating safe sound pressure levels as a function of time exposed. The maximum safe sound pressure level may be a function of how long the user has been exposed to a particular level. In other words, FIG. 2 illustrates five data points 224a-e that each indicates a sound pressure level as a function of the safe exposure time for the sound pressure level. Regulations usually recommend that the maximum exposure is eight hours per day at 85 dB SPL(A), i.e., the first data point 224a. An increase in 3 dB in sound pressure level doubles the acoustic power delivered to the user but may also decrease the allowable exposure time by half. Therefore, the product of acoustic power and exposure time (in Joules) may be constant along the curve illustrated in FIG. 2. Therefore, the regulations can be seen as effectively limiting the accumulated acoustic energy density to which the user has been exposed.

For every additional 3 dB, the maximum exposure time may be reduced by a factor of 2, e.g., four hours per day at 88 dB SPL(A) indicated by the second data point 224b. If a user only listens to music for a short time during the day, the safe exposure could be much higher. A person that listens to music for 30 minutes a day could listen to this music at a level of 97 dB SPL(A) indicated by the fifth data point 224e. Furthermore, a third data point 224c may indicate that a sound pressure level of 91 dB SPL(A) is safe for 2 hours and a fourth data point 224d may indicate that a sound pressure level of 94 dB SPL(A) is safe for 1 hour.

In one configuration, the headset may regulate the volume during 12-hour windows. For example, if a user has already listened to four hours of music at 95 dB SPL(A), then the headset may limit its output to 75 dB SPL(A), until late in the evening, at which point the headset may not play any more music since the user has exceeded his/her daily allowance for audio excitation. Alternatively, the headset may use a 24-hour window for the total noise exposure measurement, so that the user's exposure in any 24-hour period is monitored and controlled. Alternatively, an eight-hour window may be used.

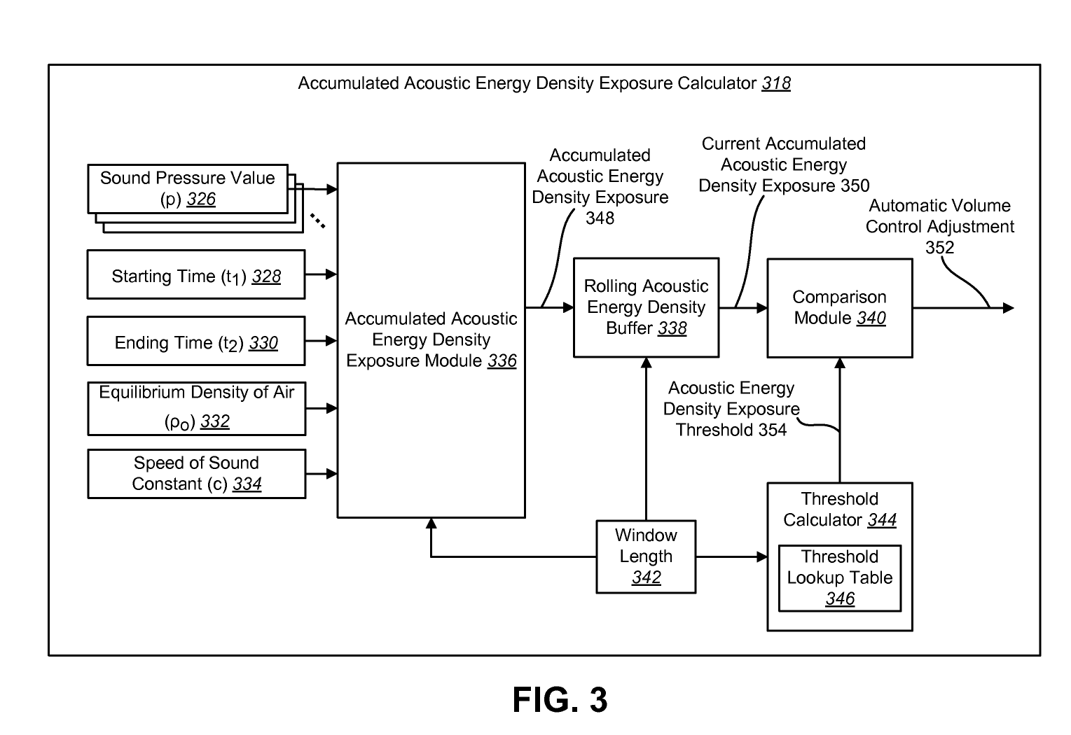

FIG. 3 is a block diagram of an acoustic energy density exposure calculator 318 in an audio digital signal processor (DSP) 116. For example, the accumulated acoustic energy density exposure calculator 318 may be in a headset 102 or a wireless communication device 104. An accumulated acoustic energy density exposure module 336 may be used to determine an accumulated acoustic energy density exposure 348 during a window based on various inputs. In one configuration, the inputs include current sound pressure values (p) 326, a starting time (t₁) 328, an ending time (t₂) 330, the equilibrium density of air (ρₒ) 332 (e.g., 1.21 kg/m³), and a speed of sound constant (c) 334 (e.g., 340 m/s or 343 m/s). The starting time (t₁) 328 and ending time (t₂) 330 may be combined into a single duration and may be determined by a media player module 122a-b or a timer internal to the audio DSP 116. Within any window (e.g., 24 hours), the accumulated exposure that a user can safely be exposed to is equivalent to 85 dB SPL(A) over a continuous period of 8 hours.

We can write the time average of the acoustic energy density for a plane wave traveling along the ear canal according to Equation (1):

$${〈 ɛ ( t ) 〉}_{{t}_{2} - {t}_{1}} = \frac{1}{{t}_{2} - {t}_{1}} {\int }_{{t}_{1}}^{{t}_{2}} \frac{{p}^{2}}{{ρ}_{0} {c}^{2}} d t \qquad ( 1 )$$

where [symbol] ε(t) [symbol] ₜ_{₂}₋ₜ_{₁} is the time average of the acoustic energy density during the exposure time window (t₂−t₁) (i.e., t₁ is the starting time 328, t₂ is the ending time 330). The value (t₂−t₁) may be 8 hours, 12 hours, 24 hours, etc., depending on the window used.

In a linear scale, the pressure corresponding to 85 dB SPL(A) is determined according to Equation (2):

$$85 dB SPL ( A ) = 20 {log}_{10} \frac{{P}_{e}}{20 E - 6} \qquad ( 2 )$$

where Pₑ is the measured effective pressure of the plane wave in the ear canal. Therefore, Pₑ equals 0.355 Pascals (Pa) for 85 dB SPL(A). The accumulated acoustic energy density exposure 348 can be expressed in terms of discrete-time components and effective pressure quantities according to Equation (3):

$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ] \qquad ( 3 )$$

where frml is the time length of the measurement frame for the acoustic sound pressure, i is a measurement frame counter and Pₑ(i) is the measured effective acoustic sound pressure during the frame i. Furthermore, the accumulated acoustic energy density exposure time window (t₂−t₁) of 8 hours (28800 seconds) using a frame length of 1 second may be given according to Equation (4):

$$\sum {〈 ɛ ( t ) 〉}_{28800 - 0} = 1 {\sum }_{i = 0 / 1}^{i = 28800 / 1} \frac{{0.355}^{2}}{1.21 * {343}^{2}} = 0.0255 [ J \text{/} {m}^{3} ] \qquad ( 4 )$$

Therefore, the accumulated acoustic energy density exposure 348 may be determined periodically based on all sound pressure values (p) 326 in the current window. Specifically, a log of the accumulated acoustic energy density exposure 348 may be maintained for the last 24 hours by updating a rolling acoustic energy density buffer 338 every 1 second and discarding the oldest value (e.g., 24 hours ago). In other words, the buffer 338 may store the result of Equation (3) for every 1 second frame (e.g., 86400 frames in a 24 hour period). The last frame may be discarded for every new frame that is fed in and volume adjustment may occur once the average of all the frames in the buffer 338 (e.g., the average of the 86400 frames) exceed the established threshold 354.

Although the window is described herein as 24 hours, other window lengths 342 may be used, e.g., 8 hours, 12 hours, etc. Likewise, the rolling acoustic energy density buffer 338 may be updated more or less frequently than 1 second, e.g., 2, 3, 4, 5 6, 8, 10 seconds, etc.

A current accumulated acoustic energy density exposure 350 may be compared to an accumulated acoustic energy density exposure threshold 354 using a comparison module 340. The current accumulated acoustic energy density exposure 350 may be the sum of multiple accumulated acoustic energy density exposures 348 during the window length 342. The threshold 354 may correspond to the window length 342 used. Specifically, a threshold lookup table 346 in a threshold calculator 344 may determine the threshold 354 based on whether the window length 342 is 8 hours, 12 hours, 24 hours, etc. In other words, the threshold 354 may be different depending on the window size.

Based on the comparison, the accumulated acoustic energy exposure density calculator 318 may send an automatic volume control adjustment 352 to the automatic volume control module 120. For example, if the current acoustic energy density exposure 350 has exceeded the threshold 354, the volume may be muted or reduced significantly, e.g., reduced by 40%, 50%, 60%, etc. On the other hand, if the current accumulated acoustic energy density exposure 350 is sufficiently below the threshold 354, the volume may not be lowered, e.g., if the accumulated acoustic energy density exposure level is at least 20% below the threshold, at least 30% below the threshold, at least 40% below the threshold, etc.

Therefore, the accumulated acoustic energy density exposure calculator 318 may use both an “accumulated energy density” (i.e., the accumulated acoustic energy density exposure 348) and a “current accumulated energy density” (i.e., the current accumulated acoustic energy density exposure 350). The accumulated acoustic energy density exposure 348 may refer to a period where a device is in use, e.g., activated by the media player 122a-b start and stop functions (these may define t1 and t2). On the other hand, the current accumulated acoustic energy density exposure 350 may refer to the total accumulated signal within a period of e.g. 24 hours. Therefore, the “current accumulated energy” may be a sum of multiple “accumulated energy densities” controlled by the rolling window buffer 338. The current accumulated acoustic energy density 350 may then be compared to a threshold 354.

In one configuration, the volume may be adjusted based on an inverse mapping of the integrated energy. For example, high volume may be allowed if the current accumulated acoustic energy density exposure 350 for each 24-hour window is low, with the max volume decreasing as the current accumulated acoustic energy density exposure 350 rises for the window. This automatic volume adjustment may be in addition to other functions performed at the automatic volume control module 120, such as noise cancellation.

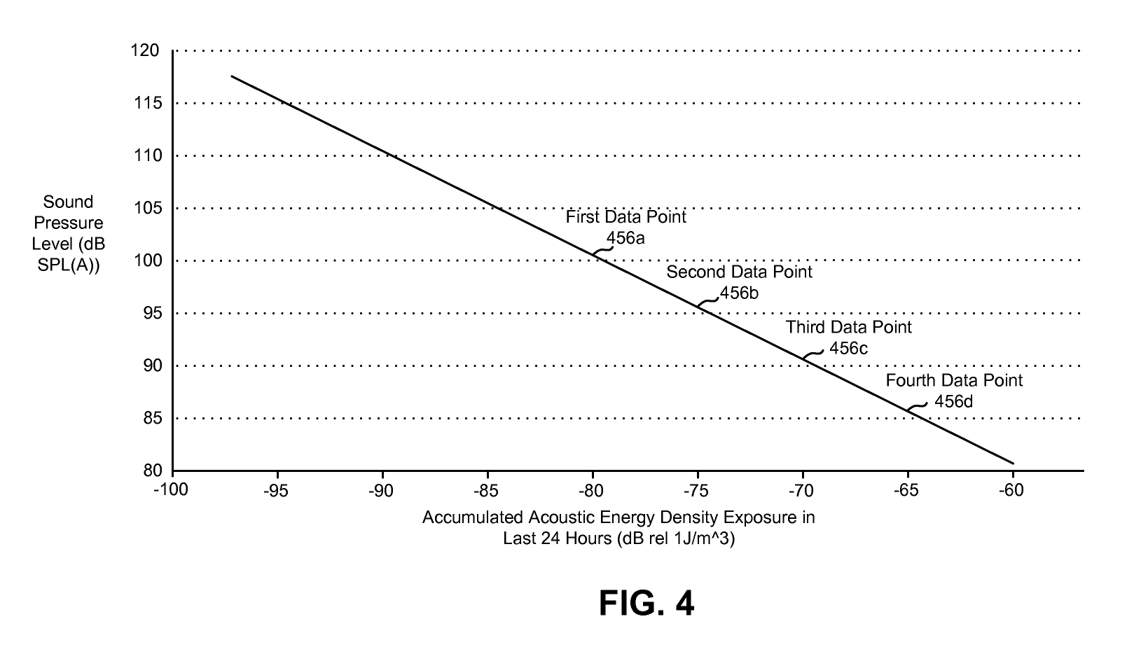

FIG. 4 is a plot illustrating output limit as a function of accumulated acoustic energy density exposure. Specifically, FIG. 4 illustrates volume reduction as a function of the current accumulated acoustic energy density exposure 350 for the current window. While FIG. 4 is illustrated as using a 24 hour window, other window durations may be used. The Y axis of the plot illustrates attenuation in the acoustic pressure output, i.e., sound pressure. The X axis illustrates the current acoustic energy density exposure 350 for the last 24 hours.

Therefore, a first data point 456a indicates that when the current accumulated acoustic energy density exposure 350 is −80 dB relative to 1 J/m³, the volume may be reduced such that the sound pressure output is limited to around 101 dB SPL(A). Similarly, a second data point 456b indicates that when the current accumulated acoustic energy density exposure 350 is −75 dB relative to 1 J/m³, the volume may be reduced such that the sound pressure output is limited to around 96 dB SPL(A). Similarly, a third data point 456c for −70 dB and 91 dB SPL(A), a fourth data point 456d for −65 dB and 86 dB SPL(A).

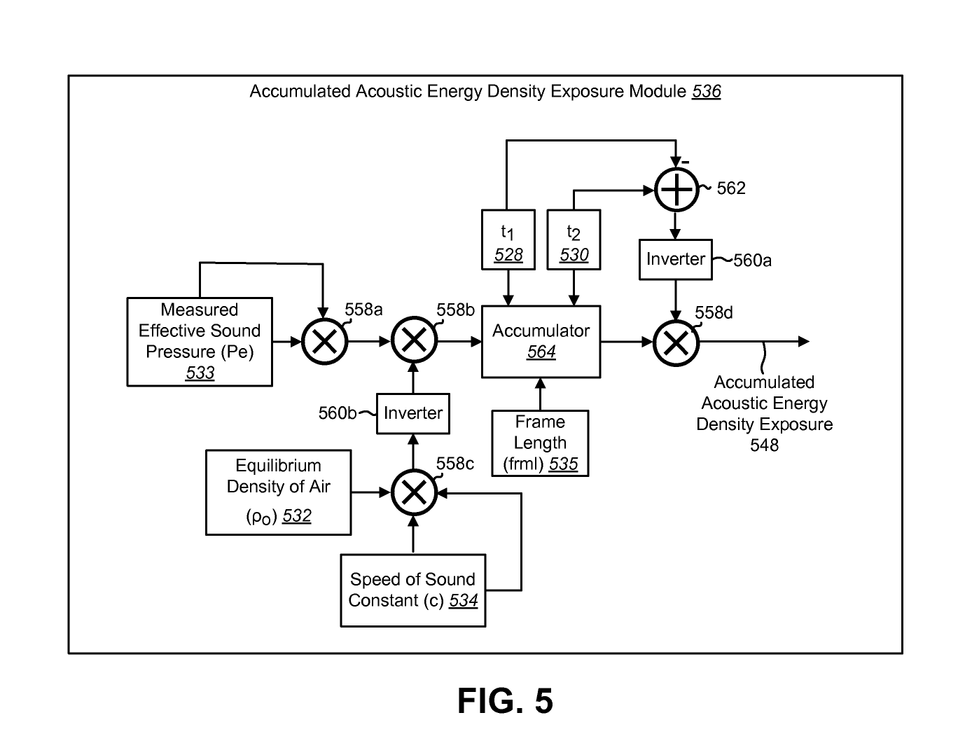

FIG. 5 is a block diagram illustrating an accumulated acoustic energy density exposure module 536. The accumulated acoustic energy density exposure module 536 may be in an accumulated acoustic energy density exposure module 336 in an accumulated acoustic energy density exposure calculator 318. Specifically, the accumulated acoustic energy density exposure module 536 may determine an accumulated acoustic energy density exposure 548 according to Equation (3).

The accumulated acoustic energy density exposure module 536 may use a combination of multipliers 558a-d, inverters 560a-b and adder(s) 562 to produce an accumulated acoustic energy density exposure 548. Specifically, the measured effective sound pressure values (Pₑ(i)) 533 may be squared (i.e., multiplied by itself) and divided by the product of the equilibrium density of air (ρₒ) 532 and the speed of sound constant (c) 534. The quotient

$$( \frac{{P}_{e}^{2}}{{ρ}_{o} {c}^{2}} )$$

may then be accumulated from the starting time (t₁) 528 to the ending time (t₂) 530 using an accumulator 564 to produce the accumulated acoustic energy density exposure 548 based on one or more measured effective sound pressure values (Pₑ(i)) 533. In one configuration, the accumulation may be performed from t1/frml to t2/frml as shown in Equation (3), i.e., accounting for the frame length (frml) 535.

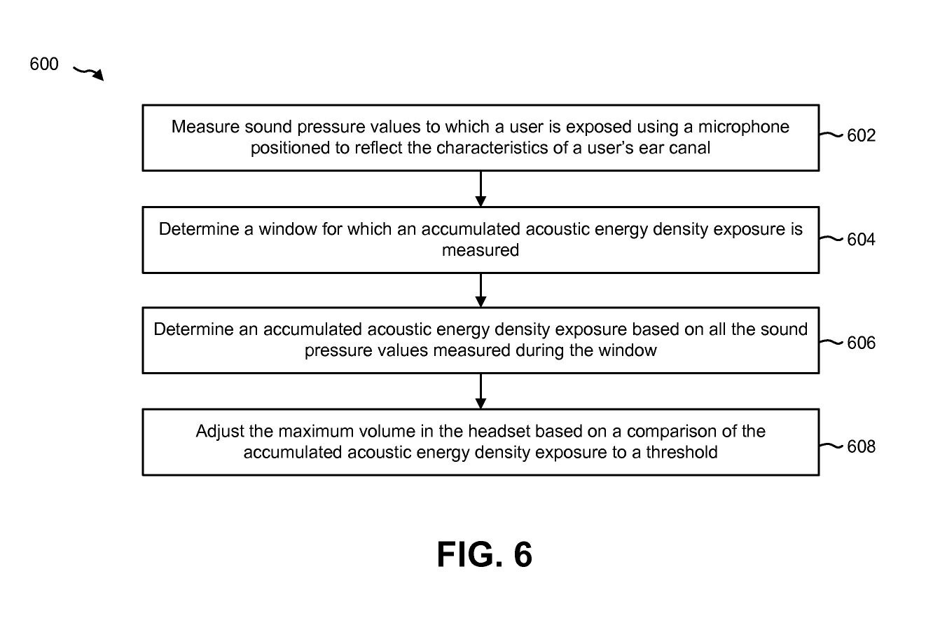

FIG. 6 is a flow diagram illustrating a method 600 for automatic volume control based on acoustic energy exposure. The method 600 may be performed by a headset 102 or a wireless communication device 104, e.g., the audio DSP 116 within the wireless communication device 104. The headset 102 or wireless communication device 104 may measure 602 sound pressure values to which a user is exposed. This may be done using a microphone 108 that is positioned to reflect the characteristics of a user's ear canal, i.e., the microphone 108 may be positioned in the ear canal. This measurement may be periodic, (e.g., every 1 second) and the measured values may be current sound pressure values. The headset 102 or wireless communication device 104 may also determine 604 a window for which an accumulated acoustic energy density exposure is measured, e.g., 8 hours, 12 hours, 24 hours, etc. The headset 102 or wireless communication device 104 may also determine 606 an accumulated acoustic energy density exposure 348 based on all the sound pressure values measured during the window. In one configuration, sound pressure values at different levels may be measured during this window, e.g., four hours at 85 dB SPL(A) and three hours at 88 dB SPL(A) within the same window. The present systems and methods may use both of these values when determining the acoustic energy density exposure 348. In other words, the acoustic energy density exposure 348 may account for multiple sound pressure levels within the analysis window.

The headset 102 or wireless communication device 104 may also adjust 608 the maximum volume in the headset 102 based on a comparison of the accumulated acoustic energy density exposure 348 to an acoustic energy density exposure threshold 354. This may include reducing the maximum volume if the accumulated acoustic energy density exposure 348 is near or above the threshold 354. Alternatively, the volume may not be adjusted if the accumulated acoustic energy density exposure 348 is far below the threshold 354.

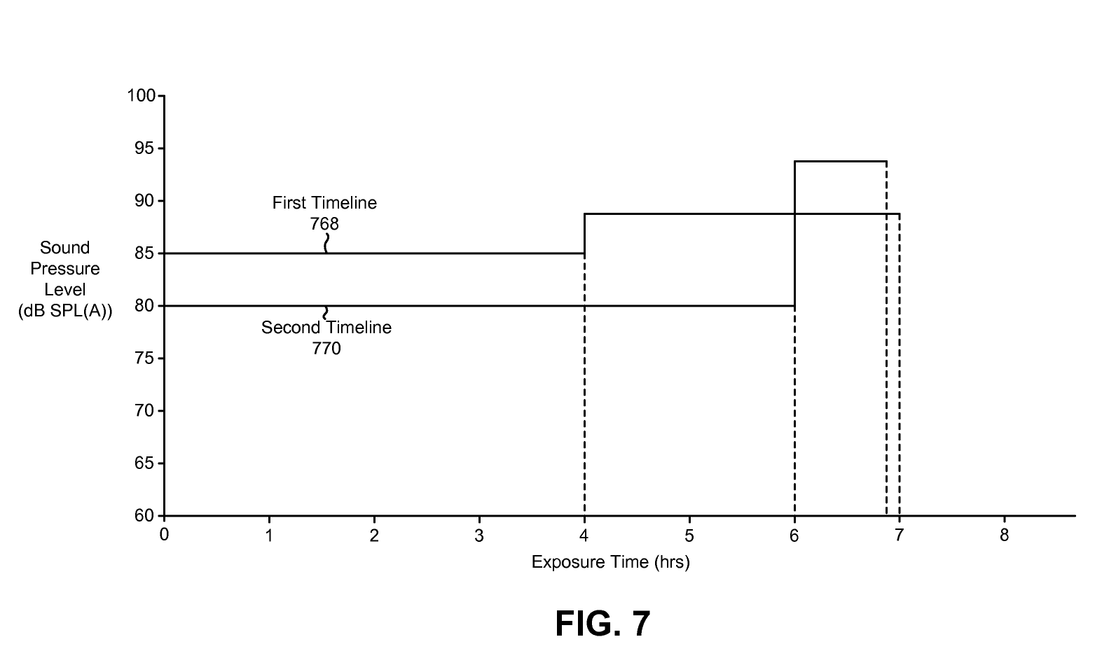

FIG. 7 is a plot illustrating two timelines 768, 770 for which the present systems and methods may limit the volume in a headset 102. Specifically, the timelines 768, 770 illustrate configurations where the present systems and methods may limit the volume, but other systems may not.

In a first configuration, one possible way to prevent hearing damage is to compare the sound pressure level experienced by a user to a threshold. In other words, using a timer to determine the duration that the sound pressure experienced by a user is above a threshold, e.g., 85 dB SPL(A) for 8 hours, 88 dB SPL(A) for 4 hours, 91 dB SPL(A) for 2 hours, etc. Furthermore, multiple timers may run at the same time, e.g., if the sound pressure is 90 dB SPL(A), the timer for 85 dB SPL(A) and 88 dB SPL(A) may both run. However, this does not actually limit the user's exposure based on an assessment of the accumulated acoustic energy density that, by definition, includes all acoustic power that has been radiated to the user over a given period of time, regardless of whether the sound pressure level has exceeded the threshold or not. In other words, the true physical quantity that needs to be limited is the cumulative acoustical energy, not necessarily the current sound pressure level. Therefore, simply breaking sound pressure levels into acceptable time periods does not protect a user from the infinite possible combinations of sound pressure exposure over different time periods.

In contrast, the present systems and methods limit volume in a headset 102 or wireless communication device 104 based on the cumulative acoustic energy density experienced by the user. For example, the present systems and methods may be thought of as continuously filling an acoustical energy bucket until a user has exceeded the energy limit threshold. Using the timelines 768, 770, FIG. 7 illustrates configurations where the present systems and methods may more accurately identify unsafe acoustic energy density exposure compared to other systems, such as the first configuration.

In the first timeline 768, the user may be listening to audio at 85 dB SPL(A) for 4 hours, at which time the volume is increased to produce a sound pressure level of 88 dB SPL(A) for another three hours. In the first configuration, neither the four hours at 85 dB SPL(A) or the three hours at 88 dB SPL(A) exceeds the relevant durations. In other words, a user may be allowed to listen to audio for eight hours at 85 dB SPL(A) without harm and four hours at 88 dB SPL(A) without harm according to the first configuration. However, substitution of the values in Equation (3) shows that the accumulated acoustic energy density exposure over the 7 hours of usage exceeds the maximum permissible limit for accumulated acoustic energy density exposure (0.0255 J/m³), as shown in Equation (5):

$$\sum {〈 ɛ ( t ) 〉}_{7 hrs} = frml {\sum }_{i = t 2 / frml}^{i = t 3 / frml} \frac{{{P}_{e\_ 1} ( i )}^{2}}{{ρ}_{o} {c}^{2}} + frml {\sum }_{i = t 1 / frml}^{i = t 2 / frml} \frac{{{P}_{e \_ 2} ( i )}^{2}}{{ρ}_{o} {c}^{2}} \\ \sum {〈 ɛ ( t ) 〉}_{7 hrs} = {\sum }_{i = 14400}^{i = 25200} \frac{{{P}_{e \_ 88 dB SPL} ( i )}^{2}}{1.21 {( 343 )}^{2}} + {\sum }_{i = 1}^{i = 14399} \frac{{{P}_{e \_ 85 dB SPL} ( i )}^{2}}{1.21 {( 343 )}^{2}} \\ \begin{matrix}\sum {〈 ɛ ( t ) 〉}_{7 hrs} = \frac{( 0.252 * 10800 )}{142355.29} + \frac{( 0.126 * 14400 )}{142355.29} \\ = \frac{2721.6 + 1814.4}{142355.29} \\ = 0.03186 [ J \cdot s \text{/} {m}^{3} ]\end{matrix} \qquad ( 5 )$$

Therefore, the first configuration will not determine the first timeline 768 to be harmful to the user. In contrast, for a window of at least eight hours (e.g., 8 hours, 24 hours, etc.), the combination of all the energy exposure during the four hours at 85 dB SPL(A) and the three hours at 88 dB SPL(A) exceeds the safe limit using the present systems and methods. Therefore, the volume may be limited for the first timeline 768 using the present systems and methods, but not using the first configuration.

Similarly, in the second timeline 770, the user may be listening to audio at 80 dB SPL(A) for 6 hours, at which time the volume is increased to produce a sound pressure level of 94 dB SPL(A) for slightly less than one hour. In the first configuration, neither the six hours at 80 dB SPL(A) or the portion of one hour at 94 dB SPL(A) exceeds the relevant durations. In other words, a user may be allowed to listen to audio indefinitely at 80 dB SPL(A) without harm and one full hour at 94 dB SPL(A) without harm according to the first configuration. Therefore, the first configuration will not determine the second timeline 770 to be harmful to the user. In contrast, for a window of at least eight hours (e.g., 8 hours, 24 hours, etc.), the combination of all the energy exposure during the six hours at 80 dB SPL(A) and the portion of one hour at 94 dB SPL(A) exceeds the safe limit using the present systems and methods. Therefore, the volume may be limited for the second timeline 770 using the present systems and methods, but not using the first configuration.

In one configuration of the present systems and methods, the rolling acoustic energy density buffer 338 is updated during the time window where the media player is active and operating in headset mode. For the time period that the media player is disabled, the buffer 338 may be filled with zeros or with an average estimate of the user's noise exposure during the day.

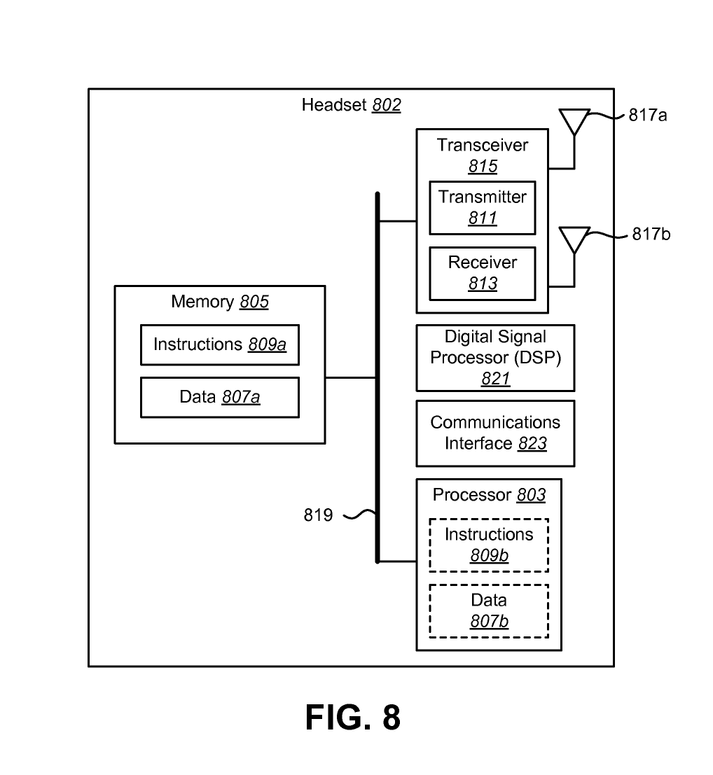

FIG. 8 illustrates certain components that may be included within a headset 802. For example, the headset 802 may be the headset 102 illustrated in FIG. 1. The headset 802 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the headset 802 of FIG. 8, in an alternative configuration, a combination of processors (e.g., an ARM and DSP) could be used.

The headset 802 also includes memory 805. The memory 805 may be any electronic component capable of storing electronic information. The memory 805 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The headset 802 may also include a transmitter 811 and a receiver 813 to allow transmission and reception of signals to and from the headset 802. The transmitter 811 and receiver 813 may be collectively referred to as a transceiver 815. Multiple antennas 817a-b may be electrically coupled to the transceiver 815. The headset 802 may also include (not shown) multiple transmitters, multiple receivers, multiple transceivers and/or additional antennas.

The headset 802 may include a digital signal processor (DSP) 821. The headset 802 may also include a communications interface 823. The communications interface 823 may allow a user to interact with the headset 802.

The various components of the headset 802 may be coupled together by one or more buses, which may include a power bus, a control signal bus, a status signal bus, a data bus, etc. For the sake of clarity, the various buses are illustrated in FIG. 8 as a bus system 819.

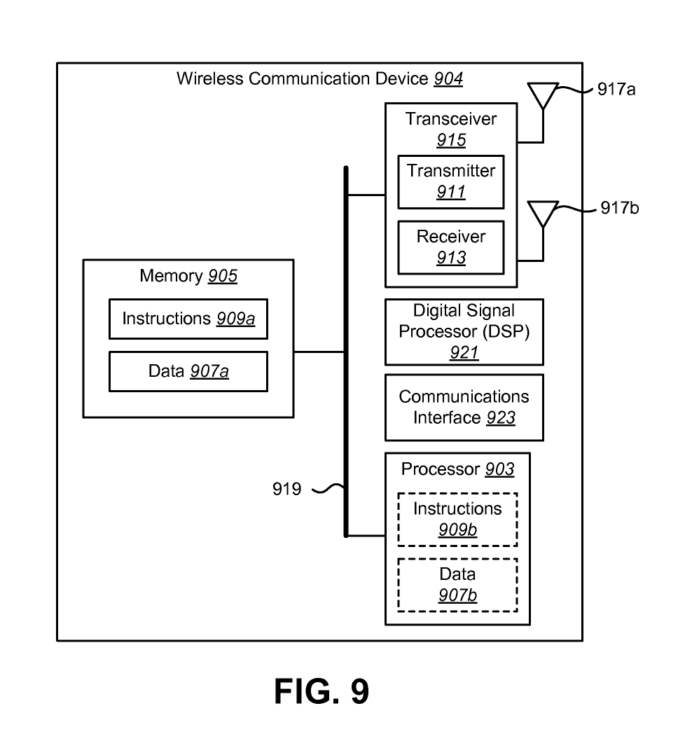

FIG. 9 illustrates certain components that may be included within a wireless communication device 904. The wireless communication device 904 may be an access terminal, a mobile station, a user equipment (UE), etc. The wireless communication device 904 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 904 of FIG. 9, in an alternative configuration, a combination of processors (e.g., an ARM and DSP) could be used.

The wireless communication device 904 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909a, various portions of the instructions 909b may be loaded onto the processor 903, and various pieces of data 907b may be loaded onto the processor 903.

The wireless communication device 904 may also include a transmitter 911 and a receiver 913 to allow transmission and reception of signals to and from the wireless communication device 904. The transmitter 911 and receiver 913 may be collectively referred to as a transceiver 915. Multiple antennas 917a-b may be electrically coupled to the transceiver 915. The wireless communication device 904 may also include (not shown) multiple transmitters, multiple receivers, multiple transceivers and/or additional antennas.

The wireless communication device 904 may include a digital signal processor (DSP) 921. The wireless communication device 904 may also include a communications interface 923. The communications interface 923 may allow a user to interact with the wireless communication device 904.

The various components of the wireless communication device 904 may be coupled together by one or more buses, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for adjusting a maximum volume in a headset based on accumulated acoustic energy density exposure, comprising:
measuring a sound pressure value of a microphone positioned in a user's ear canal;
determining a current accumulated acoustic energy density exposure based on sound pressure values measured during a rolling window; and
adjusting the maximum volume in the headset based on a comparison of the current accumulated energy density exposure to a predetermined threshold.

2. The method of claim 1, wherein the measuring is performed every 1 second.

3. The method of claim 1, wherein the determining the current accumulated acoustic energy density exposure comprises determining an accumulated acoustic energy density exposure according to the following equation:
$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ]$$
where frml is the time length of the measurement frame for the acoustic sound pressure, i is a measurement frame counter and Pₑ(i) is the measured effective acoustic sound pressure during the frame i, t₁ is a starting time of the rolling window, t₂ is an ending time of the rolling window, ρₒ is an equilibrium density of air and c is a speed of sound constant.

4. The method of claim 3, wherein the determining the current accumulated acoustic energy density exposure further comprises summing multiple accumulated acoustic energy density exposures during the rolling window.

5. The method of claim 4, wherein the rolling window spans one of at least 8 hours, 24 hours or one week.

6. The method of claim 4, wherein the rolling window spans at least one hour.

7. The method of claim 1, further comprising periodically updating a table of sound pressure level measurements for a time period where a media player coupled to the headset is active in headset mode.

8. A headset for adjusting a maximum volume based on accumulated acoustic energy density exposure, comprising:
a processor;
memory in electronic communication with the processor;
instructions stored in the memory, the instructions being executable by the processor to:
measure a sound pressure values of a microphone positioned in a user's ear canal;
determine a current accumulated acoustic energy density exposure based on sound pressure values measured during a rolling window; and
adjust the maximum volume in the headset based on a comparison of the current accumulated acoustic energy density exposure to a predetermined threshold.

9. The headset of claim 8, wherein the sound pressure values are measured every 1 second.

10. The headset of claim 8, wherein the instructions executable to determine the accumulated acoustic energy density exposure comprise instructions executable to determine an accumulated acoustic energy density exposure according to the following equation:
$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ]$$
where frml is the time length of the measurement frame for the acoustic sound pressure, i is a measurement frame counter and Pₑ(i) is the measured effective acoustic sound pressure during the frame i, t₁ is a starting time of the rolling window, t₂ is an ending time of the rolling window, ρₒ is an equilibrium density of air and c is a speed of sound constant.

11. The headset of claim 10, wherein the instructions executable to determine the current accumulated acoustic energy density exposure further comprise instructions executable to sum multiple accumulated acoustic energy density exposures during the rolling window.

12. The headset of claim 11, wherein the rolling window spans one of at least 8 hours, 24 hours or one week.

13. The headset of claim 11, wherein the rolling window spans at least one hour.

14. The headset of claim 8, further comprising instructions executable to periodically update a table of sound pressure level measurements for a time period where a media player coupled to the headset is active in headset mode.

15. A headset for adjusting a maximum volume based on accumulated acoustic energy density exposure, comprising:
means for measuring a sound pressure value of a microphone positioned in a user's ear canal;
means for determining a current accumulated acoustic energy density exposure based on sound pressure values measured during a rolling window; and
means for adjusting the maximum volume in the headset based on a comparison of the current accumulated acoustic energy density exposure to a predetermined threshold.

16. The headset of claim 15, wherein the measuring is performed every 1 second.

17. The headset of claim 15, wherein the means for determining the current accumulated acoustic energy density exposure comprise means for determining an accumulated acoustic energy density exposure according to the following equation:
$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ]$$
where frml is the time length of the measurement frame for the acoustic sound pressure, i is a measurement frame counter and Pₑ(i) is the measured effective acoustic sound pressure during the frame i, t₁ is a starting time of the rolling window, t₂ is an ending time of the rolling window, ρₒ is an equilibrium density of air and c is a speed of sound constant.

18. The headset of claim 17, wherein the means for determining the current accumulated acoustic energy density exposure further comprise means for summing multiple accumulated acoustic energy density exposures during the rolling window.

19. The headset of claim 18, wherein the rolling window spans one of at least 8 hours, 24 hours or one week.

20. The headset of claim 18, wherein the rolling window spans at least one hour.

21. The headset of claim 15, further comprising means for periodically updating a table of sound pressure level measurements for a time period where a media player coupled to the headset is active in headset mode.

22. A computer-program product for adjusting a maximum volume in a headset based on accumulated acoustic energy density exposure, the computer-program product comprising a non-transitory computer-readable medium having instructions thereon, the instructions, comprising:
code for causing a headset to measure a sound pressure value of a microphone positioned in a user's ear canal;
code for causing the headset to determine a current accumulated acoustic energy density exposure based on sound pressure values measured during a rolling window; and
code for causing the headset to adjust the maximum volume in the headset based on a comparison of the current accumulated acoustic energy density exposure to a predetermined threshold.

23. The computer-program product of claim 22, wherein the measuring is performed every 1 second.

24. The computer-program product of claim 22, wherein the code for causing a headset to determine the current accumulated acoustic energy density exposure comprises code for causing the headset to determine an accumulated acoustic energy density exposure according to the following equation:
$$\sum {〈 ɛ ( t ) 〉}_{{t}_{2} - {t}_{1}} = frml {\sum }_{i = t 1 / frml}^{i = t 2 / frml} \frac{{{P}_{e} ( i )}^{2}}{{ρ}_{o} {c}^{2}} [ J \text{/} {m}^{3} ]$$
where frml is the time length of the measurement frame for the acoustic sound pressure, i is a measurement frame counter and Pₑ(i) is the measured effective acoustic sound pressure during the frame i, t₁ is a starting time of the rolling window, t₂ is an ending time of the rolling window, ρₒ is an equilibrium density of air and c is a speed of sound constant.

25. The computer-program product of claim 24, wherein the code for causing a handset to determine the current accumulated acoustic energy density exposure further comprises code for causing a handset to sum multiple accumulated acoustic energy density exposures during the rolling window.

26. The computer-program product of claim 25, wherein the rolling window spans one of at least 8 hours, 24 hours or one week.

27. The computer-program product of claim 25, wherein the rolling window spans at least one hour.

28. The computer-program product of claim 22, further comprising code for causing the headset to periodically update a table of sound pressure level measurements for a time period where a media player coupled to the headset is active in headset mode.

29. The computer-program product of claim 22, further comprising code for causing the headset to determine the accumulated acoustic energy density exposure based on an averaged acoustic energy density exposure and a length of the rolling window.

30. The computer-program product of claim 22, further comprising code for causing the headset to update a time history of sound pressure levels over the rolling window.
